(19) United States
(12) Patent Application Publication
(10) Pub. No.: US 2026/0301189 A1
(43) Pub. Date: Oct. 1, 2026

(54) METHOD FOR SEGMENTATION AND MODELING OF LOWER SURFACE OF A CYLINDRICAL HOLE OR OVERLAP WITH AN UNDERLYING FEATURE

(71) Applicant: Applied Materials Israel Ltd., Rehovot (IL)

(72) Inventors: Mordehay AMIRIM, Tkuma (IL); Anna LEVANT, Rehovot (IL); Mira HERMONI, Jerusalem (IL); Yosef YEHOSHUA, Tel-Aviv (IL); Ahram LEE, Suwon-si (KR); Dror ALUMOT, Tel-Aviv (IL); Ji Ho KIM, Seongnam-si (KR); Tal FRANK, Tel-Aviv (IL)

(21) Appl. No.: 19/093,197

(22) Filed: Mar. 27, 2025

(51) Int. Cl. G06T 7/13; G06T 7/11; G06T 7/136; G06T 7/149; G06V 10/46; G06V 10/764

(52) U.S. Cl. CPC G06T 7/13; G06T 7/11; G06T 7/136; G06T 7/149; G06V 10/46; G06V 10/764; G06T 2207/30148

(57) ABSTRACT

In a system and method for determining the geometry of a feature bound by a lower surface of a hole in a semiconductor wafer, an imager obtains a top level image containing a top surface of the hole and a bottom level image containing a bottom surface of the hole. A classifier classifies occlusion of the bottom surface of the hole based on crude measurement of an offset between geometric centers of both surfaces, and a processing unit coupled to the classifier approximates an occluded bottom surface by assigning weights to respective edge pixels of the bottom surface and finding a contour corresponding to an ideal reference geometry that best fits the pixels based on their respective weights.

### FIELD OF THE INVENTION

This invention relates to image segmentation and modelling, particularly in the context of semiconductor inspection.

### BACKGROUND OF THE INVENTION

Hole structures are widely used in semiconductor chip fabrication, such as contact holes and channel holes in three-dimensional memory devices. Deep holes whose diameter is at least an order of magnitude smaller than their depths are known as High Aspect Ratio (HAR) holes. Typical values of hole diameter and depth may be in the order of 30 nm and 1.2 μm, respectively, i.e. an aspect ratio of 40. The ever-increasing demand for larger-capacity memories such as dynamic random access memories (DRAM) results in holes of continually higher aspect ratio. Fabrication of deep holes suffers from multiple challenges, such as slanting sidewalls and misalignment with other features of the wafer structure. Slanting channel holes affect final yield significantly in HAR 3D NAND memory wafer processing. Therefore, inline measurement of hole structures in semiconductor chip fabrication becomes important for product yield.

Semiconductor wafers are inspected during or after manufacture by directing light or electrons to the wafer and detecting the light or electrons from the wafer. A variety of non-destructive examination tools includes, by way of non-limiting example, scanning electron microscopes, atomic force microscopes, optical inspection tools, etc. In an electron microscope image of a very deep slanted hole, the wall surface of the slanted hole that is uppermost may partially or fully occlude the contour of the lower surface. This happens because of the geometry of the hole combined with the way electrons travel and interact with the sample since the uppermost wall surface of the slant will be closer to the electron beam source compared to the lower surface.

The uppermost wall surface acts like a physical barrier, blocking the electron beam's line of sight to parts of the lower wall surface. Since the upper wall extends outward above the lower surface (depending on the slant angle), it effectively “hides” the full contour of the lower surface from being directly imaged.

Slant is defined as the lateral offset between the respective centers of the top and bottom surfaces of a hole. Similarly, overlay is defined as the distance between the center of the cylindrical hole, and the center of the bottom feature (assuming they are designed to be coaxial). These are important metrics in semiconductor wafer inspection because if the lateral offset is too large, a contact hole may fail to connect to vertically aligned components on adjacent layers of the wafer that should be electrically connected to each other. Conversely, the hole may form an electrical connection between laterally displaced components on adjacent layers, which should be electrically insulated from each other. To this extent, any lateral offset between the center of the bottom surface of the hole and the center of an underlying component reduces the effective contact area and is therefore an important metric in determining whether the wafer meets the design spec.

During inspection using a scanning electron microscope (SEM), a high-energy electron beam is directed to a semiconductor wafer and is typically directly reflected by the top of the hole. Only the high energy electrons have sufficient energy to reach the bottom of the hole, while lower energy electrons are generated owing to partial absorption with the inner wall surface of the hole from which they are reflected. This produces two images from a single scan—one image is the lower surface of the hole and the other shows the upper contour.

### SUMMARY OF THE INVENTION

In one aspect, the present disclosure is directed to an improved algorithm for determining the bottom surface of hole, part of whose surface is occluded. Occlusion may be caused by a slanting wall surface of the hole or by partial overlap with an underlying feature. In one application, the top and bottom surfaces of the hole are constructed, allowing their respective centers to be computed. The slant of the hole is then determined as the lateral offset between the respective centers of the top and bottom surfaces.

### BRIEF DESCRIPTION OF THE DRAWINGS

In order to understand the invention and to see how it may be carried out in practice, embodiments will now be described, by way of non-limiting example only, with reference to the accompanying drawings, in which:

FIGS. 1a and 1b show respectively a perspective view of an ideal hole and its scanned image;

FIGS. 2a and 2b show respectively a perspective view of a slanted hole and its scanned image;

FIG. 3 shows scanned image contours of a bottom surface of a hole and variations in surface geometries constructed therefrom by changes in geometric parameters;

FIGS. 4a and 4b show schematically two different geometries of top and bottom surfaces corresponding to variations in occlusion of the bottom surface;

FIG. 5 is a schematic diagram showing details of classification according to the present invention;

FIG. 6a shows schematically a top surface and an occluded bottom surface;

FIG. 6b shows superimposed on the geometry as FIG. 6a, a bottom surface constructed according to the present invention;

FIG. 7a shows pictorially contours of a top image surface and an occluded bottom image surface and a colored graduated scale denoting relative weights assigned to pixels of the contour of the bottom surface as a function of distance of the pixel from a center of the top surface;

FIG. 7b shows pictorially contours of the top and bottom image surfaces as shown in FIG. 7a and a best-fit contour of the lower surface constructed according to the present invention;

FIG. 8 shows graphically alternative weight functions that may be used to compute the best-fit contour;

FIGS. 9a, 9b and 9c show pictorially an occluded image contour whose pixels are colored according to linear, square and gaussian weighting functions, respectively; and

FIG. 10 is a block diagram showing functionality of a system according to an embodiment the invention.

### DETAILED DESCRIPTION OF EMBODIMENTS

In the following description of some embodiments, identical components that appear in more than one figure or that share similar functionality will be referenced by identical reference symbols.

It should be understood that the method of the present disclosure, while sometimes described in reference to an SEM (Scanning Electron Microscope) image, can be applied to or on any suitable image, such as an SEM image, an X-ray image, an ultrasound image, optical image from image-based overlay metrology, optical microscopy image, etc. Additionally, template matching can be applied in multiple metrology apparatuses, steps, or determinations. For example, template matching can be applied in EPE, overlay (OVL), and CD metrology.

In this connection, some description of contour construction is desirable. Image segmentation is used to partition a digital image into meaningful regions to isolate specific features of interest. For the purpose of the present invention, the features of interest are the geometry or contours of through-holes also known as vias. Image segmentation is used to identify and measure the dimensions, shapes, and contours of through-holes for quality control and process optimization, and to highlight irregularities, such as voids, deformations, or misalignments in the holes. Several segmentation techniques can be used depending on the image quality, contrast, and requirements:
Thresholding:
   This is simple and effective for images with high contrast.
   Otsu's method or adaptive thresholding is commonly used to distinguish the vias (typically darker or lighter regions) from the background.
Edge Detection:
   Methods like Canny or Sobel operators are used to identify the boundaries of the vias based on gradients in the image.
Region-Based Segmentation:
   Techniques like region growing or watershed segmentation are effective in delineating vias when their boundaries are unclear or overlapping.
Machine Learning-Based Methods:
   Advanced approaches like convolutional neural networks (CNNs) can be trained on labeled data to identify and segment vias accurately, even under challenging imaging conditions.

An image is obtained in known manner, typically using a Scanning Electron Microscope. Noise reduction is applied using filters like Gaussian or median filters to enhance image quality and increase contrast to make vias more distinguishable. Segmentation is used to isolate vias, which are validated by comparing with ground truth i.e. reference shapes or expected results. Once vias are reliably segmented, contours are extracted and geometric properties such as area, perimeter, and aspect ratio can be computed. The use of reference shapes to represent ideal contours and performing a best-fit analysis to align the extracted pixel contours to these shapes is a powerful method for evaluating the geometry of high-aspect-ratio through holes or vias. This approach helps quantify deviations and ensure quality control in semiconductor manufacturing.

The reference shape represents the expected contour of the through hole or via. Since the hole may not be right-circularly cylindrical of constant circular cross-sectional area, different shapes may be matched to the top and bottom surfaces. The reference shape can be mathematically defined (e.g., a circle with a specified radius) or imported as a CAD vector file. Thresholding and segmentation are used as explained above and the pixels constituting the hole's top and bottom surfaces are then best-fit matched to the respective shapes using established similarity metrics. These can include Hausdorff Distance, which measures the maximum distance between points on the detected contour and the reference shape; or Chamfer Distance, which computes average distance between points; or Normalized Cross-Correlation (NCC).

Best-Fit Optimization is used to refine the alignment and fit the detected contour to the reference shape. Commonly this is done using Least-Squares Fitting to minimize the sum of squared distances between the detected contour points and the reference shape. For circles and ellipses, parameters like center coordinates, radius, and aspect ratio can be adjusted iteratively. The use of Reference Shapes to isolate the hole's top and bottom surfaces provides high precision and enables automated inspection for high-throughput environments.

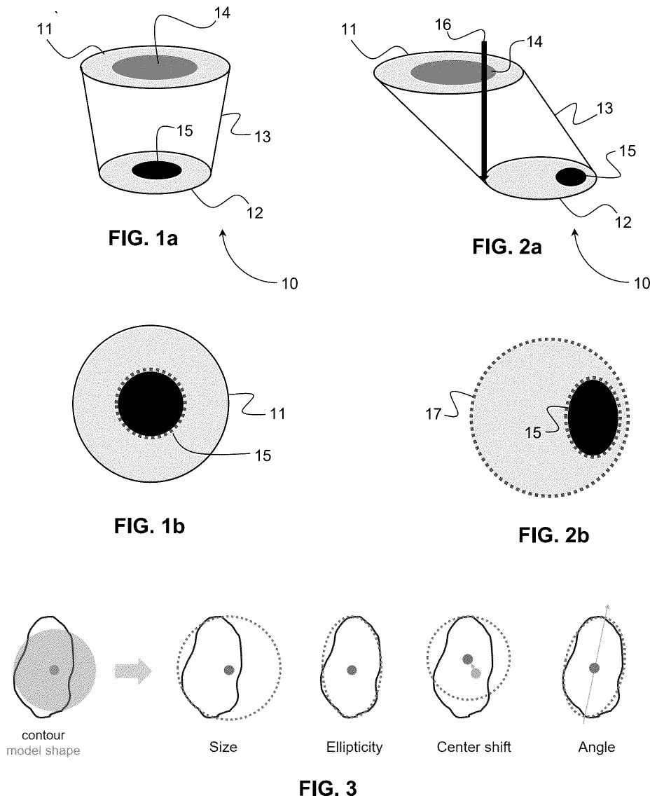

FIG. 1a relates to the ideal case where a hole is imaged and has no occlusion. The figure shows a hole 10 of generally trapezium cross-section having a top surface 11, a bottom surface 12 and a sidewall 13. During inspection, the hole is scanned from above using an electron microscope, so as to produce two images, which appear as co-planar ellipses in the figure although more typically they are circular in practice. However, the actual shapes of the top and bottom surfaces of the hole are not important provided that their desired design shapes are known. In the figure, the top surface 11 of the hole is shown grey, while the image 14 of the bottom surface of the hole is shown black.

FIG. 1b shows the pixels constituting the contour 15 of the bottom surface imaged by the scanning electron microscope. Since in this case there is no occlusion, we can fit all pixels to the best fit circle, assuming that the reference geometry is circular. As noted above, there are different ways in which the top and bottom surface images can be approximated. By way of example, we can best-fit ideal shapes that are known to the manufacturer to the images using least-squared fitting, which finds the best-fitting reference geometry for the set of image pixels by reducing the sum of the squares of the offsets of the pixels from the reference geometry.

FIG. 2a relates to the more typical case where an imaged hole 14 is partly occluded by either a slanting inner side wall surface or by an underlying feature. FIG. 2b shows the pixels 15 constituting the bottom surface imaged by the scanning electron microscope. The image 14 of the bottom surface of the hole is foreshortened and thus appears elliptical-unlike that of FIG. 1b where the bottom surface is not occluded and appears circular. The reason that the image in FIG. 2b is foreshortened is because electrons directed toward the bottom surface 12 to the left of the arrow 16 strike the side-wall 13 and only electrons to the right of the arrow 16 actually strike the bottom surface. More generally, the part of the side-wall 13 that is slanted toward the electron beam will intercept and reflect the oncoming electrons such that they will not reach the bottom surface. It is seen from FIG. 2a that the less acute is the slant, the more electrons will actually strike the bottom surface and the more closely will the imaged area of the bottom surface hole correspond to the actual surface area.

Determining the bottom surface of the hole 10 requires that the surface geometries of the hole be obtained. In some embodiments, this is done using shape-based fitting to try to fit the contour of the bottom surface image to a reference shape corresponding to the ideal shape that the user expects to see if there is no occlusion. Typically, if the cross-section of the hole is circular and there is zero slant, the ideal shape of the bottom surface is circular. Shape-based fitting is distinct from regular best-fitting, which finds the ellipse equation coefficients for minimizing the sum of the squares of distances between fitted ellipse and contour, although the invention does not preclude the use of least-squares to fit the contour to the reference shape. Shape-based fitting seeks to bound each parameter in an allowed range, determined by a model shape and defined user parameters. By way of example, this may be done in code using the scipy.optimize.curve_fit function with a corresponding fitting model.

FIG. 3 shows various examples of contours. At the left-hand side, the reference shape is shown as a light blue circle, while the contour traced by the image pixels is shown in black outline. The user can adjust various parameters or constraints to best-fit the image to the reference shape. For example, the user can determine that the size, ellipticity, geometrical centers or angular disposition of the two shapes be aligned; alternatively, the user can constrain each of the attributes to some desired range, based on prior knowledge of the expected variation in the manufacturing process.

In the case of no occlusion this is easily derived from the image 14 as shown in FIG. 1b. However, in the case where there is occlusion as shown in FIG. 2b, we need to estimate the correct geometry of the hole. Therefore, the first step in analyzing the image is to classify the image 14 as either non-occluded or occluded.

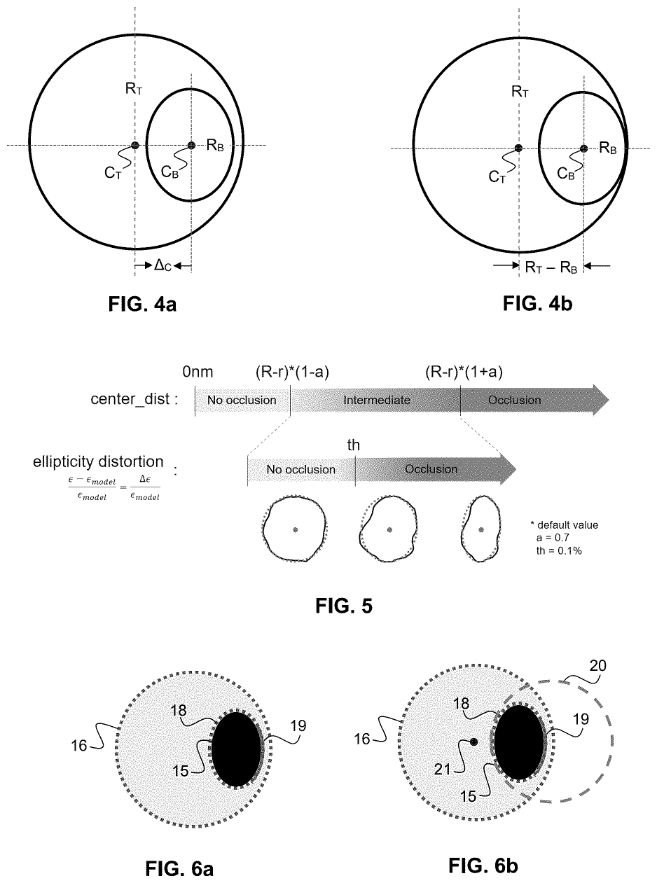

This is done by first determining the geometric center (C_{B}) of the contour 15 of the bottom surface image 14 defined by the surrounding pixels shown in dashed line and then computing the distance (Δ_{c}) between the geometric center (C_{B}) of the bottom surface and the center (C_{T}) of the top surface 11 whose contour 17 is defined by the surrounding pixels shown in dashed line. For a perfect hole whose axial center-line is vertical, C_{B} and C_{T} will be vertically aligned and Δ_{c} will be zero. In practice, it may be expected that there will be some slight departure from the ideal and Δ_{C} will be greater than zero as shown in FIG. 4a. However this in and of itself does not necessarily imply that the bottom surface is partially occluded, since a small departure from ideal may not prevent electrons from reaching and being reflected by all parts of the bottom surface.

We therefore require another metric to determine whether the bottom surface is occluded and to this end we also compute the difference Δ_{R} between the radius R_{T} along the minor axis of the best-fit ellipse defining the top surface and the radius R_{B} along the major axis of the best-fit ellipse defining the bottom surface.

FIG. 4b shows a boundary situation where the right-most contour of the bottom surface touches the right-most contour of the top surface. It is clear that the distance Δ_{R} between their respective radii is exactly equal to the distance Δ_{C} between their respective centers. Clearly, if the bottom surface were to be located any further to the right, we could assert with certainty that it is occluded.

Comparing FIGS. 4a and 4b it is seen that at the boundary of certain occlusion shown in FIG. 3b, Δ_{C}=Δ_{R}. If the image of the lower surface moves any further to the right, then for the same surface geometries, Δ_{R} will remain unchanged but Δ_{C} will increase. So, we can assert with certainty that occlusion occurs when Δ_{C}>Δ_{R}. If, for the same surface geometries, the lower surface moves to the left while still remaining to the right of the center, then Δ_{C} will decrease and therefore to the extent that Δ_{C} decreases there is less likelihood of occlusion. This would lead to the conclusion that occlusion is avoided provided that Δ_{C}<Δ_{R}. However, in practice, it is to be expected that Δ_{R} will be larger than zero because the deeper the hole, the more remote from the electron source will be the bottom surface and consequently the smaller its area will appear. Although the invention finds application also in cases where the hole is of low depth, it is particularly useful for inspecting the integrity of vias having high aspect ratio in ICs, where the depth of the hole is an order of magnitude larger than its diameter. So, to be on the safe side we weight the value of Δ_{R} by a scale factor α less than 1, for example 0.7 and classify the absence or the presence of occlusion according to whether Δ_{C}≤(1−α)·Δ_{R} or Δ_{C}>(1+α)·Δ_{R}, respectively.

This gives rise to an intermediate region defined by

$$( 1 + α ) < \frac{{Δ}_{C}}{{Δ}_{R}} \leq ( 1 - α )$$

where occlusion is indeterminate based only on Δ_{C} and Δ_{R} shown in FIG. 4. In order to establish whether an image that falls within this zone is occluded, we apply an additional classification based on ellipticity distortion, using the fact that as the bottom object becomes more occluded, its apparent ellipticity increases. Although the invention is commonly employed for inspecting holes of circular cross-section, it is not limited to circular shapes and more generally the user can specify the shape of the cross-section so as to allow the algorithm best-fit the image to the desired shape. FIG. 5 shows three image shapes that are best-fitted to reference model shapes corresponding to the expected ideal image. The normalized ellipticity ε of the best-fit ellipse as a function of the reference shape ε_{Model} is then used to classify the image as occluded if:

$$\frac{ε - {ε}_{Model}}{{ε}_{Model}} > Threshold$$

By way of example, the threshold is set 0.1% such that if the percentage ellipticity distortion of the image shape compared with the reference shape exceeds 0.1%, we treat the image shape as occluded.

At this stage of the process, the image of the bottom surface of the hole is classified as hidden or non-hidden. If the hole is non-hidden, then no special treatment is required other than to best-fit the model reference shape to the contour of the image. Having done this, we can then determine its center and measure either the slant corresponding to the offset from the center of the top surface of the hole; and/or we can measure the overlap corresponding to the offset from the center of an underlying feature, to which ideally it should be aligned.

In the case that the classifier determines that the lower image surface is partially occluded, we need to extrapolate the visible contour points to an approximation of the lower surface. This can be done in various ways among such as shape-fitting or segmentation. Our preferred approach is to fit the model reference shape to the visible part of the contour in such a manner that the location of the model reference shape best approximates the occluded surface. It is empirically clear that the choice of contour points to which the reference model is to be fitted makes a significant impact on the location of the center of the best-fit shape, and this of course affects any quantitative measurement of slant or overlap based on its center. However, it will not affect the actual shape of the reconstructed surface because this is determined solely by the reference shape, which is why we prefer this approach to segmentation. Selecting and weighting reliable contour points in bottom segmentation has been the subject of extensive effort and experimentation.

A subsequent development introduced a new way of selecting contour points based on segmentation, whereby specific contour points were selected according to predefined criteria and the model reference shape was then fitted to the selected contour points. We found that adjacent polygons may show different fitting results even though their contours are similar. Our preferred approach, therefore, is based not on selecting or classifying contour points but on using all the points for fitting but with different weights. The basic idea is that contour points remote from the top surface are more reliable as the basis for the fit owing to the potential for interference from the top surface or the sidewall.

FIG. 6a shows the image of the hole's lower surface as depicted in FIG. 2b, wherein pixels 18 on the left-hand edge of the ellipse constitute pixels that genuinely lie on the contour of the lower surface (these are color-coded blue for those jurisdictions that allow color) while pixels 19 on the right-hand edge of the ellipse constitute pixels that do not actually lie on the contour of the lower surface, these being color-coded red. The “red” pixels 19 are distorted by virtue of their being generated by electrons striking the slanting inner wall of the hole rather than by the lower surface. Assuming that the reference shape for the lower surface of the hole is circular as depicted by the violet-colored circle 20, we need to fit this to the distorted contour of the surface, giving greater weight to the blue pixels 18 than to the red pixels 19. This is done by assigning a weight to each pixel that is an inverse function of its distance from the center 21 of the top surface. Consequently, the pixels 18 on the left-hand edge of the ellipse are assigned a higher weight than the pixels 19 on the right-hand edge of the ellipse, such that the resulting approximation of the occluded lower surface of the hole is truer to the left-hand pixels 18 than to the right-hand pixels 19.

FIG. 6b shows the same surface geometries as FIG. 6a but superimposed on the occluded bottom image surface 15 is a circular contour 20 shown in dashed line constructed according to the present invention. For those jurisdictions that permit colored drawings, the constructed contour is shown in pink.

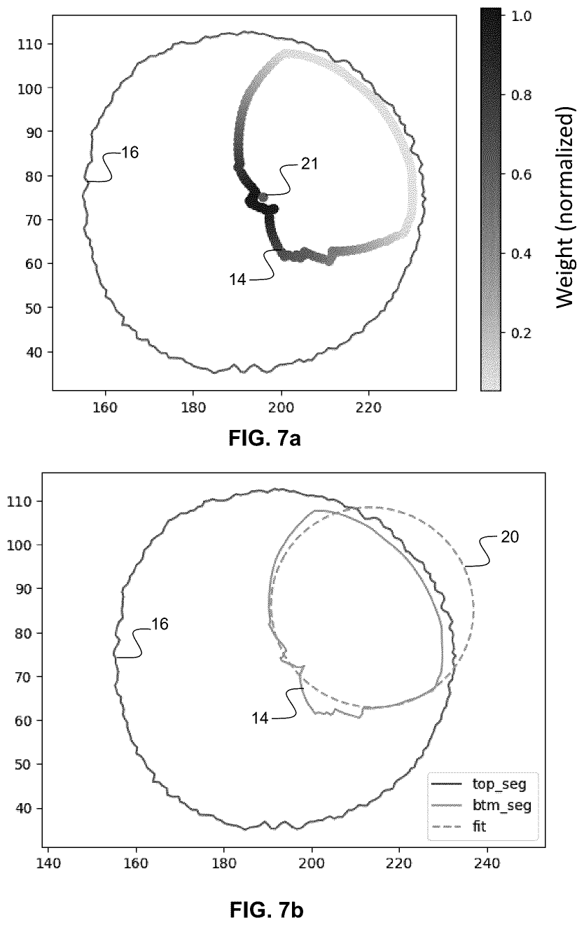

FIG. 7a shows pictorially contours of a top image surface 17 and an occluded bottom image surface 14 and a colored graduated scale denoting relative weights assigned to pixels of the contour of the bottom surface 14 as a function of distance of the respective pixel from the center 21 of the top surface 17. For those jurisdictions that permit colored drawings, the top image surface contour 17 is blue, while the color of the bottom image surface contour 14 varies as a function of the weight assigned to each pixel in accordance with the corresponding colors of the graduated scale.

FIG. 7b shows pictorially contours of the top and bottom image surfaces as shown in FIG. 7a and a best-fit contour 20 of the lower surface shown in dashed line and constructed according to the present invention. For those jurisdictions that permit colored drawings, the top image surface contour 17 is blue, while the color of the bottom image surface contour 14 and of the best-fit contour 20 are orange.

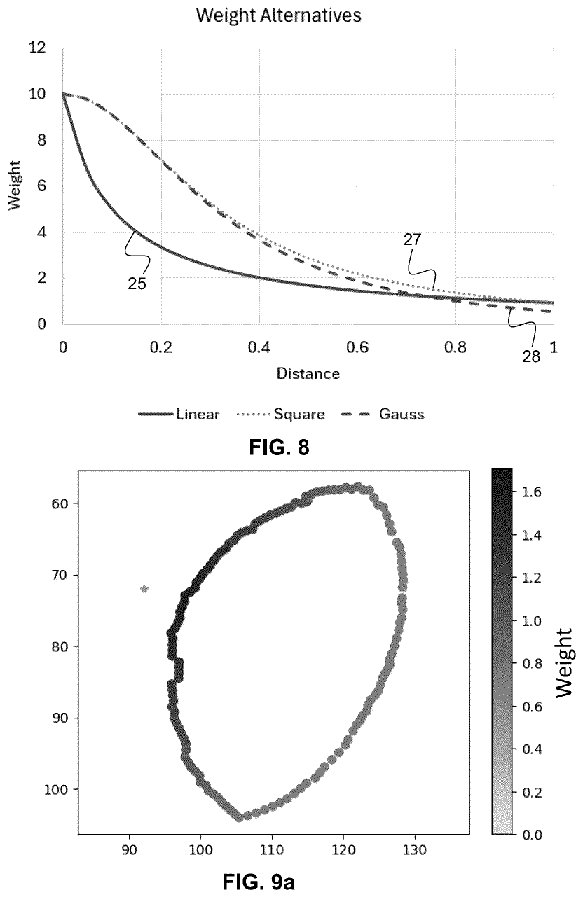

FIG. 8 shows graphically alternative color-coded weight functions that may be used to compute the best-fit contour. For those jurisdictions where color is not permitted, the curves are shown using different line types. Shown in blue (solid line) is a linear function 25 given by

$${W}_{L} ( d ) = {( \frac{d}{D} + ε )}^{- 1}$$

where:
d is the distance from each contour point and the center of the top,
D is the maximal distance over all of the polygon's contour points and the center of the top (used for normalization),
ε is a small value we have added to avoid singularity when a certain contour point lies very close to the center of the top (i.e. when d≅0). We have used ε=0.1 in the code which is why the plots start from [0, 10].

Using the same notation, the orange curve 27 (dotted line) is a square function given by

$${W}_{S} ( d ) = {[ {( \frac{d}{D} )}^{2} + ε ]}^{- 1}$$

and the green curve 28 (dashed line) is a gaussian weighting given by

$${W}_{G} ( d ) = {[ exp {( \frac{d}{D} )}^{2} - 1 + ε ]}^{- 1} .$$

In all three cases, the higher the weight applied to a pixel the more it is required that the pixel will form part of the reconstructed contour. Of course, this follows from the fact that all three weighting functions have negative powers and the invention does not negate the use of other weighting functions, which may apply higher weights to pixels that form part of the reconstructed contour.

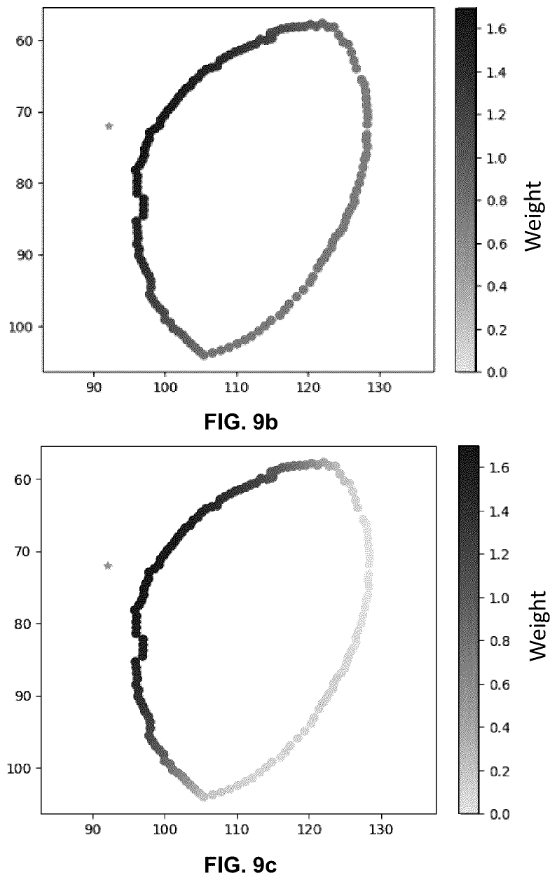

FIGS. 9a, 9b and 9c show pictorially an occluded image contour whose pixels are colored according to the linear, square and gaussian weighting functions, respectively. At the right-hand side of each contour is a graduated color scale extending from zero at the bottom to 1.6 at the top with colors ranging from deep blue to yellow. Thus, the color deep blue is applied to those pixels of the occluded contour that are assigned the lowest weight according to the selected weighting function, while yellow is applied to those pixels that are assigned the highest weight according to the selected weighting function. In fact, it is seen from FIGS. 9a and 9b that for the linear and square weighting functions, the highest weight is not applied while from FIG. 9c it is seen that the highest weight is applied to those pixels that are most remote from the center of the top surface. It is also seen empirically that the lowermost and uppermost pixels on the left-hand arc of the contour have higher weights for the gaussian weighting function than they do for the linear and square weighting functions. The shape of the constructed contour is best-fitted to the image contour in inverse proportion to the weight, such that if the reference shape is circular as shown in FIG. 7b, the reference circle matches a somewhat smaller arc of the occluded contour for the gaussian weighting than it does for the linear and square weightings, which are almost indistinguishable.

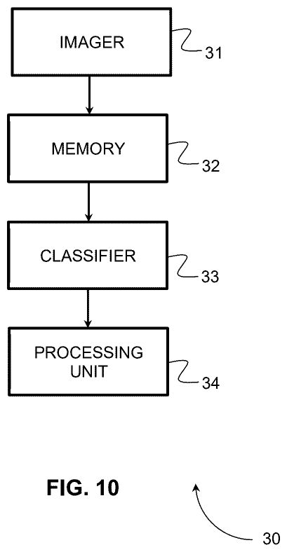

FIG. 10 is a block diagram showing functionality of a system 30 according to an embodiment of the invention for determining the geometry of a feature bound by a lower surface of a hole in a semiconductor wafer. The system comprises an imager 31 for obtaining a top level image containing a top surface of the hole and a bottom level image containing a bottom surface of the hole. The top level image and the bottom level image are stored in memory 32. A classifier 33 is coupled to the memory 32 for classifying occlusion of the bottom surface of the hole based on crude measurement of an offset between geometric centers of both surfaces. A processing unit 34 is coupled to the classifier 33 for approximating the bottom surface when classified as occluded by assigning weights to respective edge pixels of the bottom surface and finding a contour corresponding to an ideal reference geometry that best fits the pixels based on their respective weights.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A system for determining the geometry of a feature bound by a lower surface of a hole in a semiconductor wafer, the system comprising:
an imager for obtaining a top level image containing a top surface of the hole and a bottom level image containing a bottom surface of the hole;
a classifier for classifying occlusion of the bottom surface of the hole based on crude measurement of an offset between geometric centers of both surfaces;
a processing unit coupled to the classifier for approximating the bottom surface when classified as occluded by assigning weights to respective edge pixels of the bottom surface and finding a contour corresponding to an ideal reference geometry that best fits the pixels based on their respective weights.

2. The system according to claim 1, wherein the classifier is configured to:
i) classify the bottom surface as non-occluded if the offset is less than a predefined lower limit;
ii) classify the bottom surface as occluded if the offset exceeds a predefined upper limit;
iii) classify occlusion based on a measured distortion of the contour from a known ideal geometry if the offset lies in an intermediate region bound by the lower and upper limits.

3. The system according to claim 2, wherein the classifier is configured to classify the bottom surface within the intermediate region by:
i) classifying the bottom surface as non-occluded if a measured distortion is less than or equal to a predefined ellipticity distortion threshold; and
ii) classifying the bottom surface as occluded if the measured distortion is greater than said ellipticity distortion threshold.

4. The system according to claim 1, wherein the weights assigned to respective edge pixels conform to a linear function or to a square function or to a Gaussian function.

5. The system according to claim 4, wherein:
the linear function is of the form
$${W}_{L} ( d ) = {( \frac{d}{D} + ε )}^{- 1} ,$$
the square function is of the form
$${W}_{S} ( d ) = {[ {( \frac{d}{D} )}^{2} + ε ]}^{- 1} ,$$
and
the Gaussian function is of the form
$${W}_{G} ( d ) = {[ exp {( \frac{d}{D} )}^{2} - 1 + ε ]}^{- 1}$$
where:
d is the distance from each contour point and the center of the top,
D is the maximal distance over all of the polygon's contour points and the center of the top (used for normalization), and
ε is a small value added to avoid singularity when a certain contour point lies very close to the center of the top (i.e. when d≅0).

6. The system according to claim 1, wherein the top surface of the hole is derived by best-fitting a reference shape to a segmentation contour derived from the top level image.

7. A method for determining the geometry of a feature bound by a lower surface of a hole in a semiconductor wafer, the method comprising:
(a) obtaining a top level image containing a top surface of the hole and a bottom level image containing a bottom surface of the hole;
(b) classifying occlusion of the bottom surface of the hole based on crude measurement of an offset between geometric centers of both surfaces;
(c) if the bottom surface is classified as occluded, approximating the bottom surface by assigning weights to respective edge pixels of the bottom surface and finding a contour corresponding to an ideal reference geometry that best fits the pixels based on their respective weights.

8. The method according to claim 7, wherein classifying occlusion of the bottom surface of the hole includes:
i) classifying the bottom surface as non-occluded if the offset is less than a predefined lower limit;
ii) classifying the bottom surface as occluded if the offset exceeds a predefined upper limit;
iii) if the offset lies in an intermediate region bound by the lower and upper limits, classifying occlusion based on a measured distortion of the contour from a known ideal geometry.

9. The method according to claim 8, wherein classifying occlusion within the intermediate region includes:
i) classifying the bottom surface as non-occluded if a measured distortion is less than or equal to a predefined ellipticity distortion threshold; and
ii) classifying the bottom surface as occluded if the measured distortion is greater than said ellipticity distortion threshold.

10. The method according to claim 9, wherein the weights assigned to respective edge pixels conform to a linear function.

11. The method according to claim 10, wherein the linear function is of the form
$${W}_{L} ( d ) = {( \frac{d}{D} + ε )}^{- 1}$$
where:
d is the distance from each contour point and the center of the top,
D is the maximal distance over all of the polygon's contour points and the center of the top (used for normalization), and
ε is a small value added to avoid singularity when a certain contour point lies very close to the center of the top (i.e. when d≅0).

12. The method according to claim 9, wherein the weights assigned to respective edge pixels conform to a square function.

13. The method according to claim 12, wherein the square function is of the form
$${W}_{S} ( d ) = {[ {( \frac{d}{D} )}^{2} + ε ]}^{- 1}$$
where:
d is the distance from each contour point and the center of the top,
D is the maximal distance over all of the polygon's contour points and the center of the top (used for normalization), and
ε is a small value added to avoid singularity when a certain contour point lies very close to the center of the top (i.e. when d≅0).

14. The method according to claim 9, wherein the weights assigned to respective edge pixels conform to a Gaussian function.

15. The method according to claim 14, wherein the Gaussian function is of the form
$${W}_{G} ( d ) = {[ exp {( \frac{d}{D} )}^{2} - 1 + ε ]}^{- 1}$$
where:
d is the distance from each contour point and the center of the top,
D is the maximal distance over all of the polygon's contour points and the center of the top (used for normalization), and
ε is a small value added to avoid singularity when a certain contour point lies very close to the center of the top (i.e. when d≅0).

16. The method according to claim 7, wherein the top surface of the hole is derived by best-fitting a reference shape to a segmentation contour derived from the top level image.

17. The method according to claim 7, wherein the top surface and the bottom surface of the hole are derived by segmentation of an image of the hole into discrete depths based on gray level of pixels in said image.

18. A computer program product comprising a tangible memory storing computer program code which, when executed on a computer processor, accesses data stored in memory that is representative of a top level image containing a top surface of a hole and a bottom level image containing a bottom surface of the hole, and computes a geometry of a feature bound by a lower surface of a hole in a semiconductor wafer by:
(a) classifying occlusion of the bottom surface of the hole based on crude measurement of an offset between geometric centers of both surfaces; and
(b) if the bottom surface is classified as occluded, approximating the bottom surface by assigning weights to respective edge pixels of the bottom surface and finding a contour corresponding to an ideal reference geometry that best fits the pixels based on their respective weights.
